(19) United States
(12) Patent Application Publication
(10) Pub. No.: US 2009/0285103 A1
(43) Pub. Date: Nov. 19, 2009

(54) APPARATUS FOR CONTROLLING TUNNELING LOOP DETECTION

(75) Inventors: Jun Hirano, Kanagawa (JP); Chan Wah Ng, Singapore (SG); Pek Yew Tan, Singapore (SG); Tien Ming Benjamin Koh, Singapore (SG); Chun Keong Benjamin Lim, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/307,559

(22) PCT Filed: Jul. 6, 2007
(86) PCT No.: PCT/JP2007/063936

§ 371 Date: Jan. 5, 2009

(30) Foreign Application Priority Data
Jul. 7, 2006 (JP) 2006-188681

(51) Int. Cl. H04L 12/26

(52) U.S. Cl. 370/241

(57) ABSTRACT

Disclosed is a technique whereby a packet transferring apparatus (particularly, a tunnel entry point made to carry out packet encapsulation) becomes capable of detecting a tunneling loop signifying that a packet loops along the same route while undergoing encapsulation. With this technique, at packet transfer, a loop detection module of a router according to the present invention stores a TEL value (value of tunnel encapsulation limit for limiting the number of times of duplication of tunnel) set in an encapsulation header of this packet or stores a TEL value set in an encapsulation header of a packet sent back as an ICMP error In addition, the loop detection module analyzes an increase/decrease variation pattern of the stored TEL value relative to time and, in a case in which the pattern agrees with a unique pattern (sawtooth-like pattern) appearing at the occurrence of a tunneling loop, estimates that a tunneling loop has occurred.

### TECHNICAL FIELD

The present invention relates to an apparatus for controlling tunneling loop detection, which is for controlling packet encapsulation (packet tunneling) in a packet-switched data communication network.

### BACKGROUND ART

A large number of protocols pertaining to internet protocol suite employ packet encapsulation (or packet tunneling). The packet encapsulation in IPv6 (Internet Protocol version 6) is primarily defined in the following Non-Patent Document 1.

For example, in a virtual private network (VPN), the employment of a tunneling technology takes place so that two or more networks at different positions can be connected to each other so as to establish a large-scale private network.

Moreover, in the case of a mobility support of the mobile IPv6 (MIPv6), through the use of the tunneling between a mobile node and a home agent, the mobile node is always reachable at its own home address.

In the case of IPv6 network mobility support (NEMO), a mobile router establishes a tunnel with respect to its own home agent, which enables the movement of the entire network in the internet while maintaining the reachable condition of a prefix of its mobile network.

For the IPv6 tunneling, an encapsulation is made in a state where an internal IPv6 packet (inner packet) is used as a payload of an external IPv6 packet (outer packet). The inner packet is sometimes referred to as a payload packet, while the outer packet is sometimes referred to as a tunnel packet.

The tunneling is related to two entities of a tunnel entry node and a tunnel exit node. In this specification, the tunnel entry node is sometimes referred to as a tunnel entry point or TEP, while the tunnel exit node is sometimes referred to as a tunnel exit point.

The tunnel entry node encapsulates a payload packet into a tunnel packet having an address of the tunnel entry node as a source address and an address of the tunnel exit node as a destination address. When the tunnel packet reaches the tunnel exit node, the payload packet is decapsulated and set in a normal manner. Thus, an overlay network is efficiently producible on the existing routing infrastructure.

In addition, it is also appropriate that the payload packet is encrypted so as to inhibit a relay router from seeing the contents of the inner packet. Since the source and destination addresses regarding the inner packet are concealed by means of the tunneling, routing decision is made only based on the outer packet in the existing routing infrastructure.

However, in this case, in a case in which a tunnel packet returns to the tunnel entry node before reaching the tunnel exit node, there is a possibility that a phenomenon known as a tunneling loop occurs.

Moreover, in a case in which there is a need for a packet to undergo the encapsulation in a plurality of levels, the tunneling loop more easily occurs. Since the encapsulation conceals the source address of the inner packet, there is a possibility that the tunnel entry node does not find out the fact that the tunnel entry node itself already tunneled that packet in the past. The tunneling loop consumes the network resources quickly and, hence, it is not a desirable event.

Since a new hop limit field is set in each of the encapsulated packets, the packet is continuously forwarded infinitely on a tunneling loop (along the tunneling loop). In consequence, the existing mechanism using a hop limit for the prevention of a routing loop becomes invalid.

Still moreover, each encapsulation leads to the addition of an excessive packet header to the packet, which increases the size of the packet. An extreme increase of the packet size can cause the packet fragmentation, and the effect is that another packet (fragmented packet) is introduced into the tunneling loop.

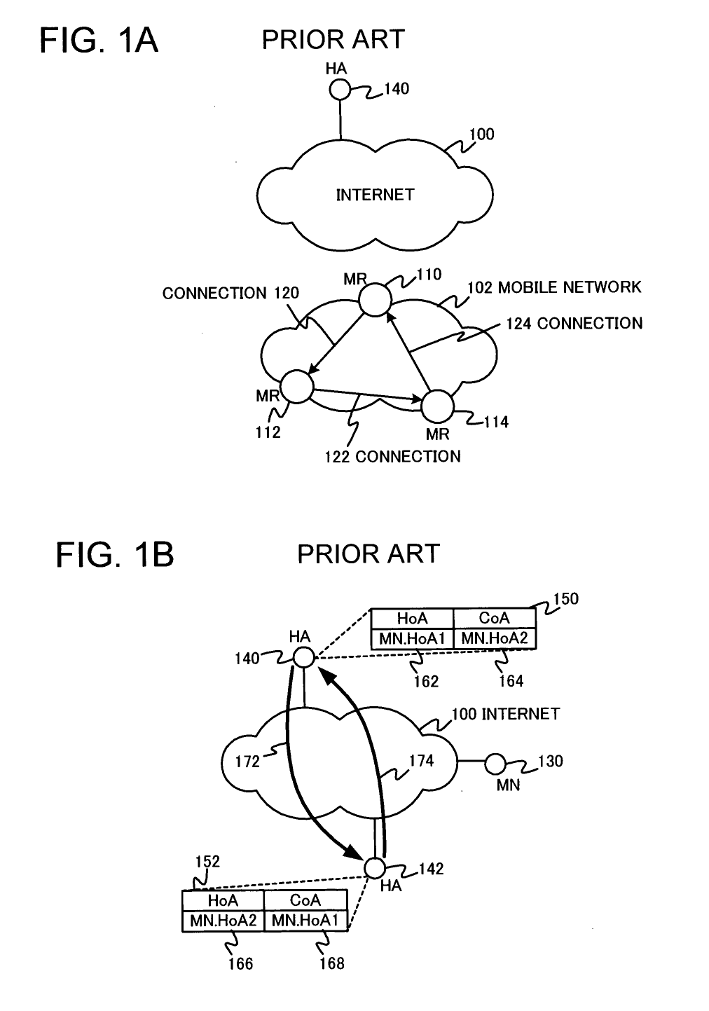

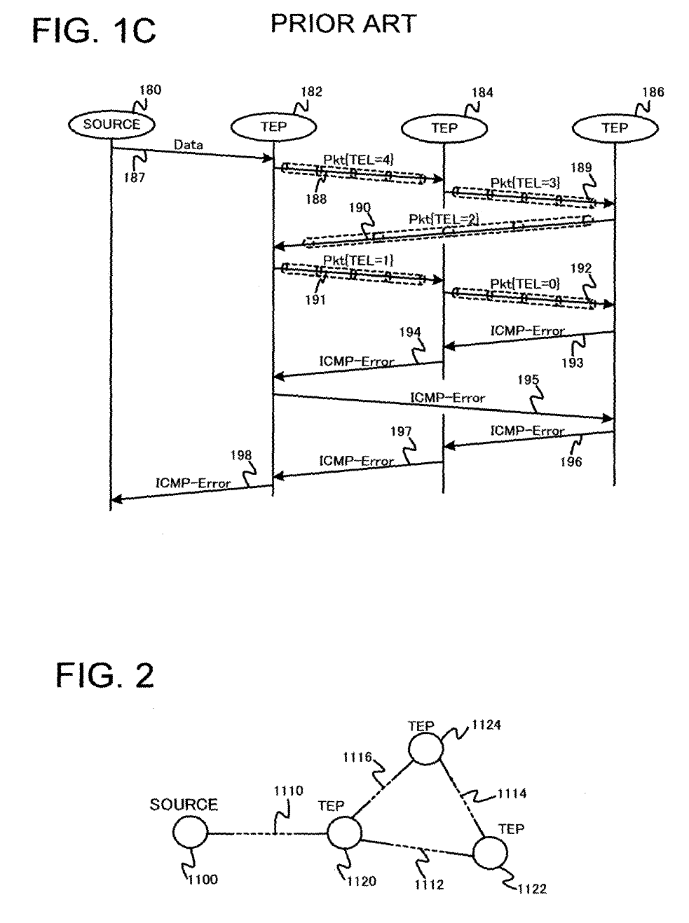

A tunneling loop will occur in many situations. FIGS. 1A and 1B are illustrations of two possible scenarios of the occurrence of tunneling loops.

In FIG. 1A, an MR (Mobile Router) 110, an MR 112 and an MR 114 are roaming in the internet 100. There is a possibility that each of the mobiles routers forms a tunneling loop.

In this configuration, the MR 110 is in connection with the MR 112 as indicated by a connection 120, the MR 112 is in connection with the MR 114 as indicated by a connection 122, and the MR 114 is in connection with the MR 110 as indicated by an connection 124. In a case in which one of the mobile routers (for example, the MR 110) makes the tunneling to its own HA (Home Agent) 140, the MR 110 encapsulates a packet for the tunneling to the HA 140 and hands over the packet to the MR 112 serving as an access router for the MR 110.

In addition, the MR 112 further encapsulates the packet for handing it over to its own home agent. The packet is handed over to the MR 114 where the packet encapsulation also takes place. This continues permanently, and each mobile router continues to append an encapsulation layer one by one to the packet.

Furthermore, FIG. 1B is an illustration of a scenario in which an MN (Mobile Node) 130 has two home addresses (MN.HoA1 and MN.HoA2) and a home agent (HA 140 or HA 142) corresponding to each of the home addresses exists.

The HA 140 manages the home address MN.HoA1, while the HA 142 manages the home address MN.HoA2. Let it be assumed that the MN 130 notifies, to the HA 140, accidentally or intentionally the fact that its own care-of address (CoA) is the MN.HoA2 and notifies, to the HA 142, the fact that its own care-of address is the MN.HoA1.

In consequence, in a binding cache 150 of the HA 140, there is stored an entry having a home address (HoA) field 162 including the MN.HoA1 and a care-of address (CoA) field 164 including the MN.HoA2. Likewise, in a binding cache 152 of the HA 142, there is stored an entry having a home address filed 166 including the MN.HoA2 and a care-of address 168 including the MN.HoA1.

In a case in which one (for example, HA 140) of the home agents receives a packet addressed to the MN 130, the HA 140 carries out the packet encapsulation so that it is transferred to a care-of address (i.e., the MN.HoA2) specified in its own binding cache. In FIG. 1B, it is indicated as a path 172.

The HA 142 receives (intercepts) this packet and tunnels the packet to the care-of address (MN.HoA1) of the MN 130 in its own binding cache 152. Thus, as indicated as a path 174 in FIG. 1B, the packet is returned through the tunnel. This loop will continue indefinitely.

The following Non-Patent Document 1 discloses that catastrophic consequences of a tunneling loop is preventable through the use of a tunnel encapsulation limit (TEL) option. This TEL option signifies a destination header option including a maximum number of encapsulations a packet permits.

Usually, an intermediate routing node is not made to inspect a destination header of a transit packet. However, in the case of the Non-Patent Document 1, a need exists that all tunnel entry nodes inspect the destination header of the packet before carrying out the encapsulation. Moreover, in a case in which the TEL option is found in destination header of the packet, there is a need for the tunnel entry node to check that the maximum number of encapsulations allowed in the TEL option does not stand at zero.

If the value specified in the TEL option stands at zero, the tunnel entry node discards the packet and transmits, to the packet origination side, an internet control message protocol (ICMP) error which is for notifying a problem to the origination side.

On the other hand, if the TEL option does not stand at zero, the tunnel entry node carries out the encapsulation processing on the packet appends a TEL option including a value, obtained by subtracting 1 from the original TEL option (TEL option at the reception of the packet), to a new tunnel packet header.

Meanwhile, when no TEL option is included in the original packet (packet received), the tunnel entry node conducts the encapsulation processing appends a TEL option containing a default value of maximum encapsulations to the tunnel packet header. This default value is a parameter set in the tunnel entry node.

Secondly, an operation related to the technique disclosed in the above-mentioned Non-Patent Document 1 is shown as an example in FIG. 1C. In this case, a source node 180 (indicated as source in FIG. 1C) is a source node made to transmit a data packet to an arbitrary destination. The packet passes through a route passing through three tunnel entry points (TEP 182, TEP 184, TEP 186). Let it be assumed that the three tunnel entry points form a tunneling loop due to miss-configuration or for other reasons.

In a case in which the source node 180 transmits a data packet 187 (indicated as Data in FIG. 1C), the data packet 187 arrives at the first tunnel entry (TEP 182). The TEP 182 encapsulates the data packet into a tunnel packet 188 and appends a TEL option to the tunnel packet header. Since no TEL option is included in a payload packet 187, in the TEL option of the tunnel packet 188, there is set a limit field set to a default value (for example, “4”).

Moreover, the TEP 184 tunnels this packet to the TEP 186, which consequently produces a packet 189 having a TEL limit of “3” (indicated as Pkt {TEL=3}). Still moreover, the TEP 186 tunnels this packet to the TEP 182, which consequently produces a packet 190 having a TEL limit of “2” (indicated as Pkt {TEL=2}). The TEP 182 again tunnels this packet to the TEP 184, with the production of a packet 191 having a TEL limit of “1” (indicated as Pkt {Tel=1}). Finally, the TEP 184 tunnels this packet to the TEP 186, with the production of a packet 192 with a TEL limit of “0” (indicated as Pkt {Tel=0}).

At this time, the TEP 186 notices that the received packet contains a TEL option with a value of zero. In consequence, the further execution of the encapsulation becomes impossible. Moreover, the TEP 186 discards the packet 192 and returns, to the source (i.e., the TEP 184) of the packet, an ICMP error message (indicated as ICMP-Error in FIG. 1C) indicative of the original TEL option 184 of the packet 192.

Upon receipt of this ICMP error message 193, the TEP 184 extracts the original packet 191 from the ICMP error message 193 and returns, to the source (i.e., the TEL 182) of the packet 191, an ICMP error message 194 (indicated as ICMP-Error in FIG. 1C) indicative of a TEL option of the packet 191.

This return of the ICMP error message is conducted until the TEL option disappears in the packet extracted from the received ICMP error message (that is, the ICMP error messages 195 to 197 (indicated as ICMP-Error in FIG. 1C) are returned in succession). Incidentally, in FIG. 1C, the TEL option disappears in the packet in a case in which the TEL 182 has received the ICMP error message 197. Then, the last ICMP error message 198 (indicated as ICMP-Error in FIG. 1C) is transmitted from the TEP 182 to the original source node 180.

Furthermore, another prior art technique exists for solving a problem related to the routing loop. For example, the following Patent Document 1 discloses a general routing loop detection method in which a counter made to count the number of packets for a predetermined period of time is provided for each hop number included in an IP header so as to estimate whether or not a routing loop occurs.

Still furthermore, a further prior art technique exists for preventing the routing loop itself. For example, the following Patent Document 2 discloses a mobile ad-hoc routing method for the purpose of the prevention of a routing loop. Yet furthermore, the following Patent Document 3 discloses a routing method using a spanning tree algorithm for preventing the occurrence of a routing loop with respect to a layer 2 tunneling protocol (L2TP) or a virtual private network (VPN).

[Non-Patent Document 1] “Generic Packet Tunneling in IPv6 Specification”, RFC2473, December, 1998

[Patent Document 1] U.S. Patent Application Publication No. 2005/0063311

[Patent Document 2] U.S. Patent Application Publication No. 2004/0146007

[Patent Document 3] U.S. Pat. No. 6,765,881

However, the technique disclosed in the Non-Patent Document 1 is capable of preventing the indefinitely continuous occurrence of tunneling loops by using the above-mentioned TEL option, but it is a solution insufficient to complicated problems. In particular, in the case of the employment of the TEL option, a receiver of an ICMP error message cannot make a judgment as to the reason that the value of the TEL becomes zero, that is, whether the value of the TEL has reached zero due to the occurrence of a tunneling loop or the value of the TEL has reached zero because the setting of the TEL value is merely insufficient to the number of tunnels needed before reaching a last destination.

Accordingly, it is unclear how to handle an ICMP error notifying that the tunnel entry node reaches a limit of tunnel encapsulation.

The tunnel entry node can attempt the passage of a packet by increasing the default TEL value. However, in a case in which a tunneling loop actually exists, there is a possibility that the reception of ICMP errors and the increase in default TEL value indefinitely take place.

In addition, it is also possible that the tunnel entry node assumes the existence of a tunneling loop and simply rejects tunnel packets having the same destination addresses. However, if the true reason for the ICMP error is that the number of tunnels is larger than the TEL value set for a packet to reach the last destination, an unnecessary service rejection can occur.

As obvious from the above description, there is a problem, arising with the employment of a TEL option, in that information whereby the tunnel entry node can distinguish between a case in which a tunneling loop occurs and a case in which the number of tunnels through which a packet is required to pass is larger than the set default TEL value is not included in the TEL option.

Moreover, the method disclosed in the Patent Document 1 is unsuitable for a router which is made to process several-thousands packets per second.

Still moreover, with respect to the methods disclosed in the Patent Documents 2 and 3, there arises a problem in that the calculation cost needed for taking the trouble of preventing the occurrence of loop does not pay, in particular, in a case in which the probability of the occurrence of a loop is considerably low. The tunneling protocol is made to utilize a basic routing infrastructure with respect to the routing of packets from the tunnel entry node to the tunnel exit node. Therefore, the above-mentioned problems also apply particularly to the tunneling protocol. Yet moreover, the actual possibility of the occurrence of a tunneling loop is considerably low, except that a routing loop exists in the basic routing infrastructure. For this reason, the tunneling protocol is unsuitable for a complete and complex loop avoidance mechanism.

### DISCLOSURE OF THE INVENTION

In consideration of the above-mentioned problems, it is an object of the present invention to provide an apparatus for controlling a tunneling loop detection, which is used when a packet transferring apparatus (particularly, tunnel entry point) detects the presence of a tunneling loop.

For achieving the above-mentioned purpose, in accordance with the present invention, there is provided an apparatus for controlling a tunneling loop detection, which is located in a packet transferring apparatus having a packet transferring function, comprising:

information collecting means for collecting information included in a packet;

information accumulating means for accumulating the information collected by the information collecting means; and

tunneling loop detecting means for detecting whether or not a tunneling loop has occurred, on the basis of the information accumulated in the information accumulating means.

The above-mentioned configuration enables a packet transferring apparatus made to transfer a packet to collect and accumulate information included in a packet to be transferred, so the presence of a tunneling loop is detectable on the basis of this information.

In addition, combined with the above-mentioned configuration, in the apparatus for controlling a tunneling loop detection according to the present invention, the information collecting means is designed to collect a value of a tunnel encapsulation limit option included in a tunnel header of the packet.

With the above-mentioned configuration, the presence of a tunneling loop becomes detectable on the basis of the value of the tunnel encapsulation limit option which is set in a tunnel packet and limits the number of times of encapsulation.

Still additionally, combined with the above-mentioned configuration, in the apparatus for controlling a tunneling loop detection according to the present invention, the information collecting means is designed to collect a value of a tunnel encapsulation limit option included in an ICMP error packet.

With the above-mentioned configuration, the presence of a tunneling loop becomes detectable on the basis of the value of the tunnel encapsulation limit option in an ICMP error packet which has been generated relative to a tunnel packet having the tunnel encapsulation limit option which is for limiting the number of times of encapsulation.

Still additionally, combined with the above-mentioned configuration, in the apparatus for controlling a tunneling loop detection according to the present invention, the information accumulating means is designed to store the information included in each of a predetermined number of packets from a lastly received packet to a transferred packet preceding by the predetermined number with respect to the lastly received packet.

With the above-mentioned configuration, the presence of a tunneling loop becomes detectable on the basis of the information included in a predetermined number of packets.

Moreover, combined with the above-mentioned configuration, in the apparatus for controlling a tunneling loop detection according to the present invention, the tunneling loop detecting means carries out statistical processing on the information accumulated by the information accumulating means to estimate whether or not the tunneling loop has occurred, on the basis of a result of the statistical processing.

With the above-mentioned configuration, the presence of a tunneling loop becomes detectable on the basis of a result of statistical processing on the information included in packets to be transferred.

Still moreover, combined with the above-mentioned configuration, in the apparatus for controlling a tunneling loop detection according to the present invention, the tunneling loop detecting means conducts processing on the information accumulated in the information accumulating means to obtain an increase/decrease pattern of values indicated by the information included in the packets relative to time and, when a result of the processing shows that the obtained pattern agrees with a sawtooth-like pattern unique to the occurrence of a tunneling loop, makes a judgment that the tunneling loop has occurred.

With the above-mentioned configuration, the presence of a tunneling loop becomes detectable by detecting that an increase/decrease pattern of the values indicated by the information included in packets to be transferred agrees with a sawtooth-like pattern peculiar to the occurrence of a tunneling loop.

Yet moreover, combined with the above-mentioned configuration, the apparatus for controlling a tunneling loop detection according to the present invention further comprises packet selecting means capable of identifying the packet individually or according to specified group, wherein the tunneling loop detecting means analyzes the information accumulated by the information accumulating means for each individual packet or each group selected by the packet selecting means so as to detect whether or not the tunneling loop has occurred.

With the above-mentioned configuration, a packet is specified individually or according to predetermined group so as to analyze the information reflecting a result of the specification, thereby enhancing the accuracy on detection of a tunneling loop.

In addition, combined with the above-mentioned configuration, in the apparatus for controlling a tunneling loop detection according to the present invention, the packet selecting means is made to identify the packet on the basis of identification information appended to the packet.

With the above-mentioned configuration, a tunnel entry point can specify a packet individually or for each group by referring to identification information appended to the packet.

Still additionally, combined with the above-mentioned configuration, the apparatus for controlling a tunneling loop detection according to the present invention further comprises identification information appending control means for executing control so that the identification information appended to the packet is held in an outermost header of the packet.

With the above-mentioned configuration, for example, ID information appended in a tunnel entry point which has conducted the first packet encapsulation is continuously held in an outermost portion of the packet, so a detailed loop mode of a tunneling loop becomes graspable.

Yet additionally, combined with the above-mentioned configuration, in the apparatus for controlling a tunneling loop detection according to the present invention, the packet selecting means is made to set the group for each set of a source address and destination address of the packet.

With the above-mentioned configuration, a packet is specified for each set of a source address and destination address of the packet, which improves the accuracy on extraction of information related to the same tunneling loops.

The present invention has the above-mentioned configurations and provides an advantage of enabling a tunnel entry point to detect the presence of a tunneling loop.

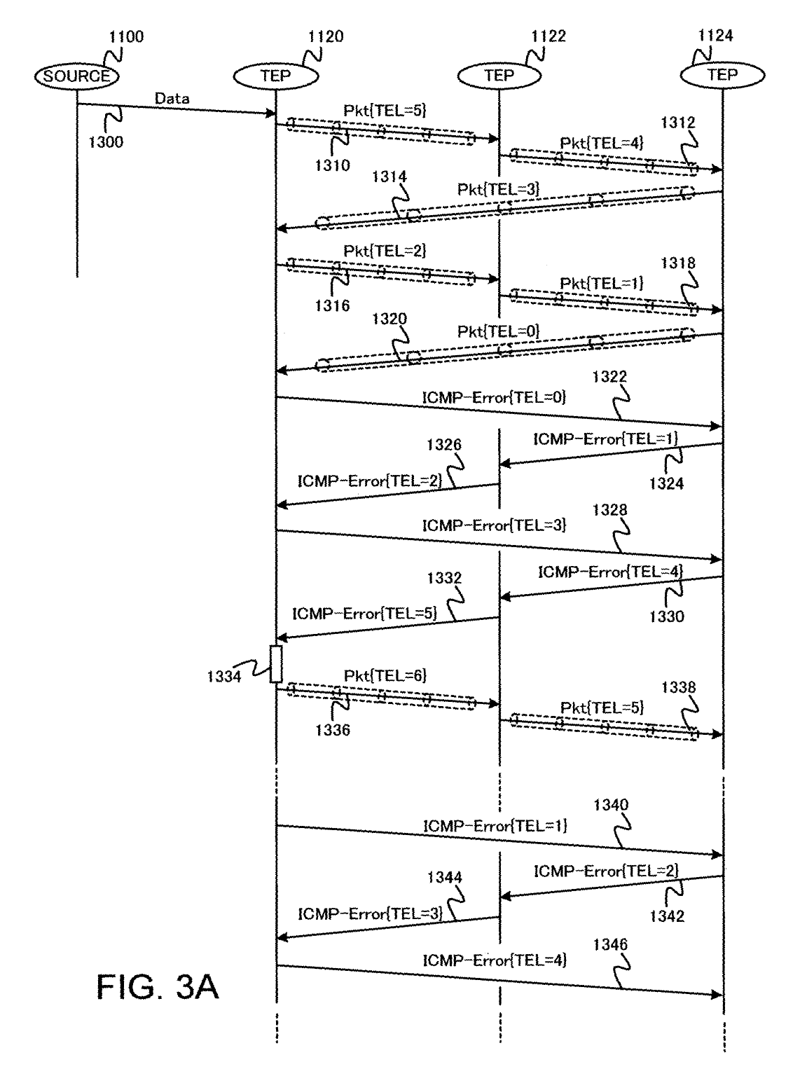

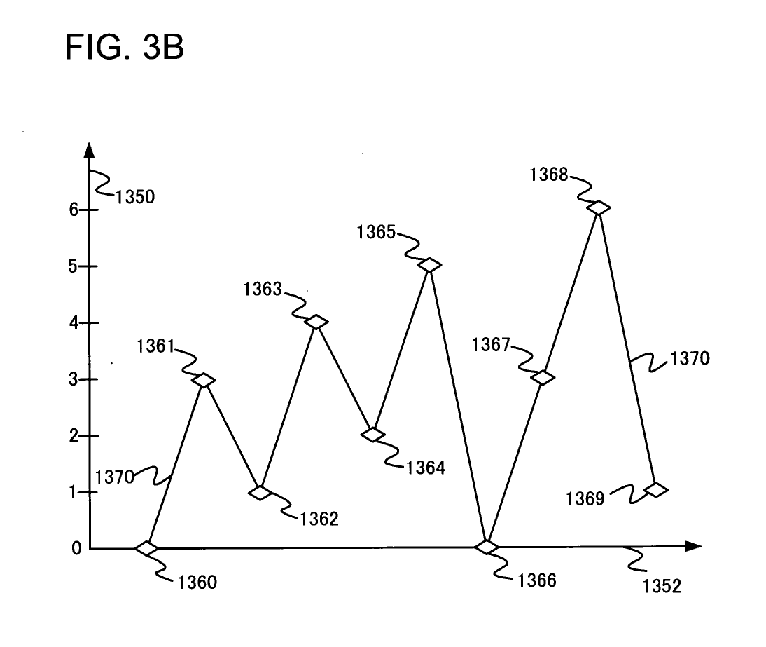

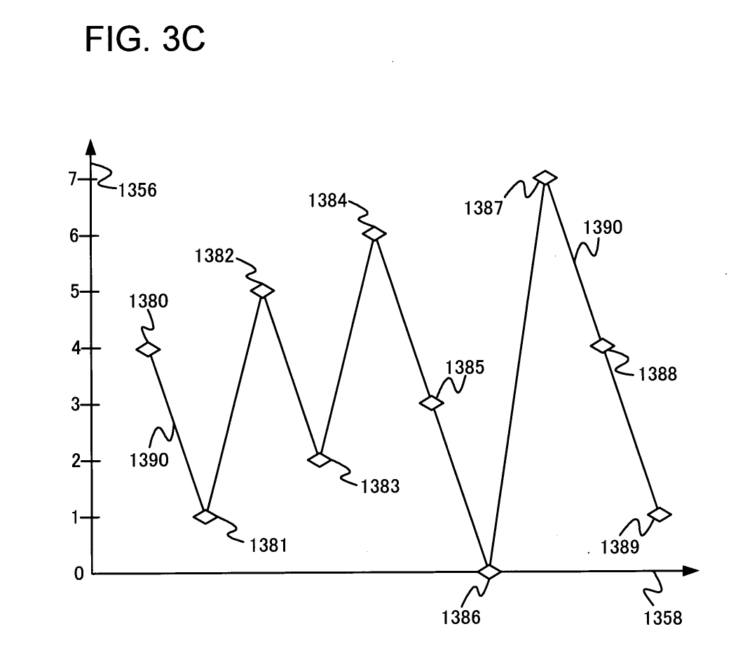

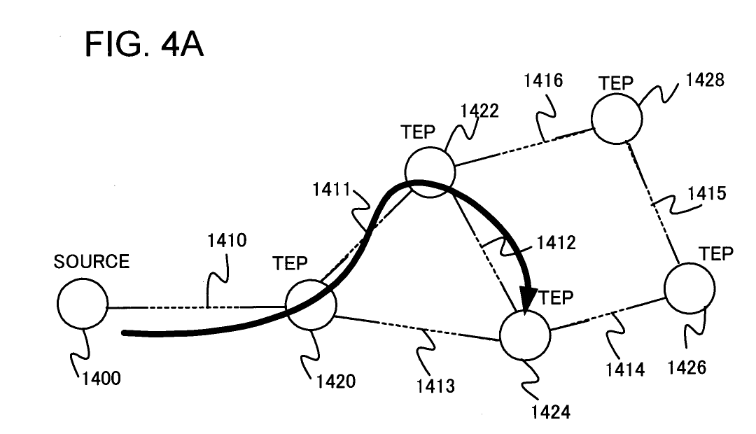

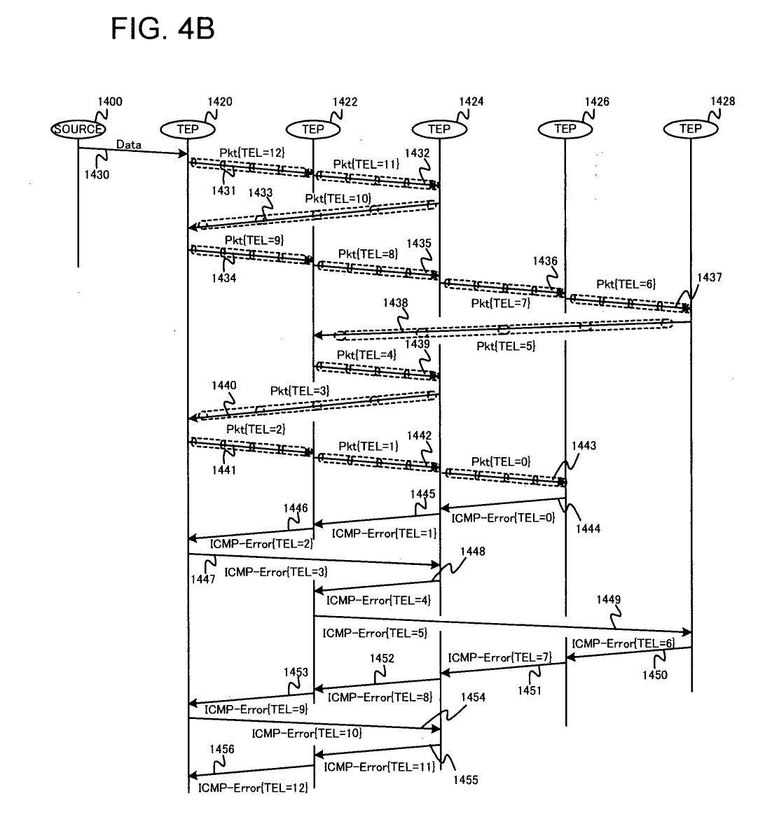

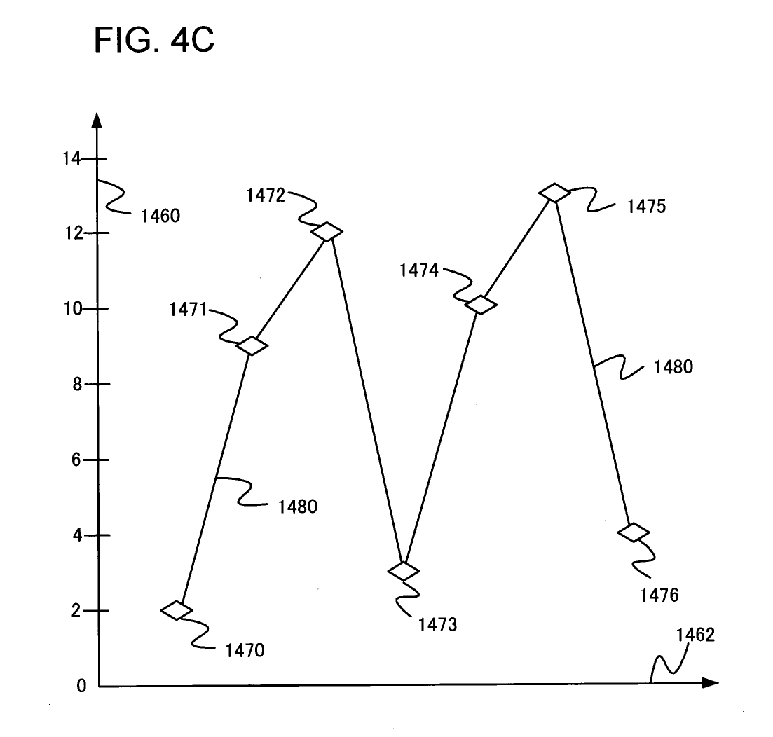

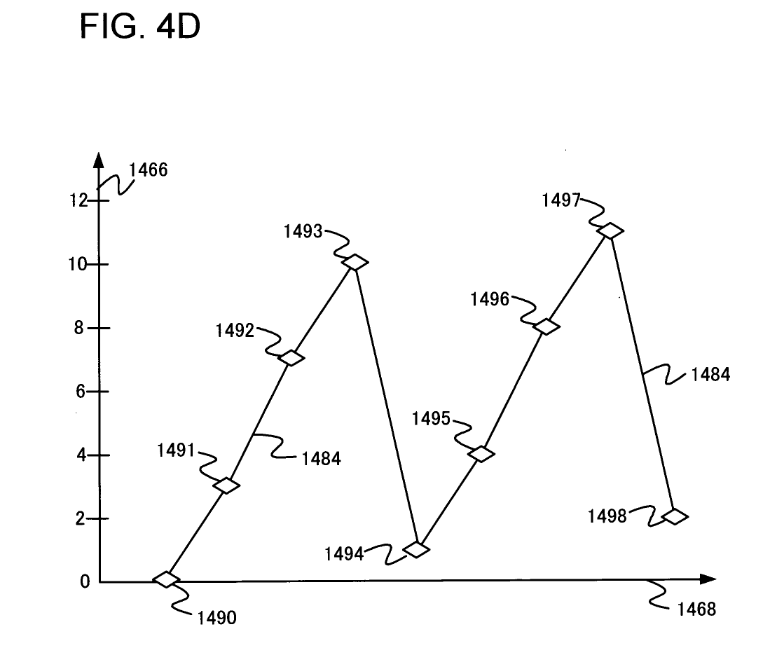

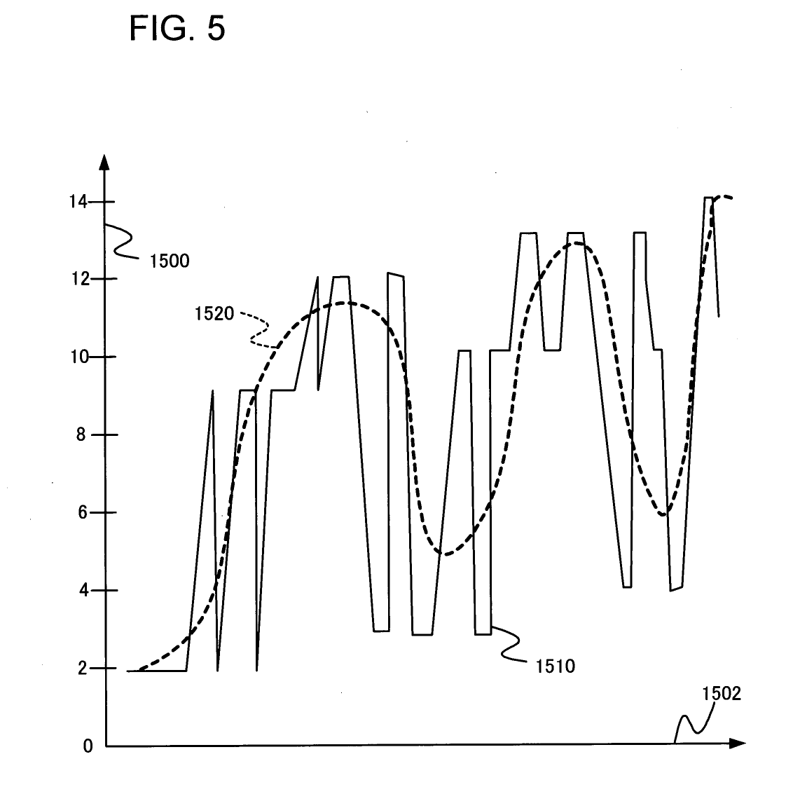

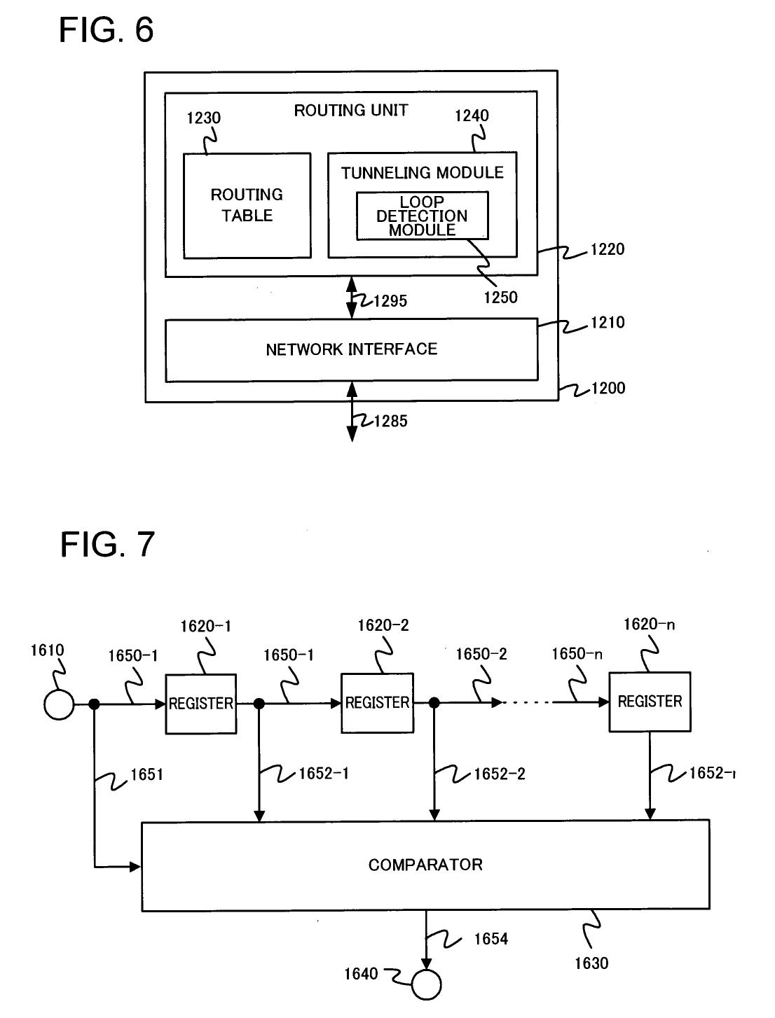

### BRIEF DESCRIPTION OF THE DRAWINGS

[FIG. 1A] is an illustration of a first configuration example of a conventional technique in which a tunneling loop is projected to occur;

[FIG. 1B] is an illustration of a second configuration example of a conventional technique in which a tunneling loop is projected to occur;

[FIG. 1C] is a sequence chart showing one example of an operation in a conventional technique;

[FIG. 2] is an illustration of one example of a network configuration in the case of a formation of a tunneling loop in an embodiment of the present invention;

[FIG. 3A] is a sequence chart showing one example of an operation according to an embodiment of the present invention;

[FIG. 3B] is an illustration of one example of a graph illustratively indicating TEL values collected from an ICMP error by a tunnel entry point in an embodiment of the present invention;

[FIG. 3C] is an illustration of one example of a graph illustratively indicating TEL values collected from a tunnel packet by a tunnel entry point in an embodiment of the present invention;

[FIG. 4A] is an illustration of another example of a network configuration in the case of a formation of a tunneling loop in an embodiment of the present invention;

[FIG. 4B] is a sequence chart showing another example of an operation according to an embodiment of the present invention;

[FIG. 4C] is an illustration of another example of a graph illustratively indicating TEL values collected from an ICMP error by a tunnel entry point in an embodiment of the present invention;

[FIG. 4D] is an illustration of a different example of a graph illustratively indicating TEL values collected from an ICMP error by a tunnel entry point in an embodiment of the present invention;

[FIG. 5] is an illustration of one example of a graph indicating TEL values actually collected from an ICMP error by a tunnel entry point in an embodiment of the present invention;

[FIG. 6] is an illustration of one example of a configuration of a tunnel entry point according to an embodiment of the present invention; and

[FIG. 7] is an illustration of one example of a configuration of a loop detection module of a tunnel entry point according to an embodiment of the present invention.

### BEST MODE FOR CARRYING OUT THE INVENTION

An embodiment of the present invention will be described hereinbelow with reference to the drawings.

According to the present invention, basically, a tunnel entry point collects a parameter (for example, the value of a TEL option (which will be referred to hereinafter as a TEL value)) obtainable from a packet to be transferred and monitors the statistic of the collected parameters, thereby estimating the presence of a tunneling loop when a unique pattern appearing when a tunneling loop has occurred is discovered in the collected statistic.

In addition, according to the present invention, in a case in which a tunneling loop has occurred, when at least one of a plurality of tunnel entry points constituting this tunneling loop is a tunnel entry point according to an embodiment of the present invention (tunnel entry point capable of detecting a tunneling loop), this tunnel entry point detects the presence of the tunneling loop.

With reference to a network configuration shown in FIG. 2, a description will be given hereinbelow of a method of realizing a scenario based upon the present invention. FIG. 2 is an illustration of one example of a network configuration in an embodiment of the present invention in a case of the establishment of a tunneling loop.

In FIG. 2, a data packet transmitted from a source node (source) 1100 first passes through a path 1110 and arrives at a tunnel entry point TEP 1120. It is also acceptable that a plurality of routers or tunnel entry points (not shown) lie on the path 1110. In this case, let it be assumed that the TEP 1120 is the first tunnel entry point made to encapsulate the data packet.

The packet encapsulated in the TEP 1120 is sent through a path 1112 to a TEP 1122, and the tunnel packet is further encapsulated therein. It is also acceptable that a plurality of routers or tunnel entry points (not shown) lie on the path 1112.

The packet encapsulated in the TEP 1122 is sent through a path 1114 to a TEP 1124, and the tunnel packet is further encapsulated therein. It is also acceptable that a plurality of routers or tunnel entry points (not shown) lie on the path 1114.

Moreover, the packet encapsulated in the TEP 1124 returns through a path 1116 to the TEP 1120. It is also acceptable that a plurality of routers or tunnel entry points (not shown) lie on the path 1116. In consequence, in the above-mentioned case, a tunneling loop develops in a state where the first tunnel entry point constitutes a portion of the loop.

In FIG. 2, in a case in which all the TEPs 1120, 1122 and 1124 area tunnel entry point based on a prior art technique, the same operation as the conventional operation described above with reference to FIG. 1C is conducted at the packet transfer. Although a tunneling loop is not detected at this time, if an arbitrary tunnel entry point of the plurality of TEPs 1120, 1122 and 1124 constituting a tunneling loop has a tunneling loop. detection function according to the present invention, the tunneling loop is detectable by this tunnel entry point.

In a case in which the TEP 1124 shown in FIG. 2 has a tunneling loop detection function according to the present invention, an operation according to an embodiment of the present invention will be described hereinbelow as one example with reference to FIG. 3A. FIG. 3A is a sequence chart of one example of an operation according to an embodiment of the present invention.

In FIG. 3A, a message sequence starts at a source node 1100 made to transmit a data packet 1300 (in FIG. 3A, indicated as Data). As well as the conventional technique, the TEP 1120 sets the TEL value, for example, at “5” and encapsulates the data packet 1300 into a tunnel packet 1310. The packet 1310 (in FIG. 3A, indicated as Pkt {TEL=5}) reaches the TEP 1122.

The TEP 1122 decrements the TEL value by one and encapsulates the packet 1310 within a tunnel packet 1312 whose TEL value is set at “4”. The packet 1312 (in FIG. 3A, indicated as Pkt {TEL=4}) reaches the TEP 1124.

The TEP 1124 decrements the TEL value by one and encapsulates the packet 1312 within a tunnel packet 1314 whose TEL value is set at “3”. When the TEP 1120 receives this tunnel packet 1314 (in FIG. 3A, indicated as Pkt {TEL=3}), the formation of a tunneling loop takes place.

The TEP 1124 is capable of conducting the processing to store the TEL value (TEL value “4”) contained in the tunnel header of the received packet 1312. The TEL value stored here is used for the detection of a tunneling loop. It is also acceptable that the TEP 1124 stores the value (the TEL value “3” set in the packet 1314) obtained by decrementing the TEL value, contained in the tunnel header of the received packet 1312, by one.

The TEP 1120 cannot detect or presume a tunneling loop even by referring to the received packet 1314, and it carries out similar processing to transmit a tunnel packet 1316 (in FIG. 3A, indicated as Pkt {TEL=2}) where the TEL value is set at “2”. Likewise, the TEP 1122 and the TEP 1124 transmit tunnel packets 1318 and 1320 (in FIG. 3A, indicated as Pkt {TEL=1} and Pkt {TEL=0}) where the TEL values are set at “1” and “0”, respectively, and the tunnel packet 1320 where the TEL value is set at “0” arrives at the TEL 1120. Moreover, even at the time of the reception of the packet 1318, the TEP 1124 conducts the processing to store the TEL value (TEL value “1”) contained in the tunnel header of the received packet 1318.

The receiver (i.e., TEP 1120) of the tunnel packet 1320 where the TEL value is set at “0” transmits, to the transmitter (TEP 1124), an ICMP error (ICMP error message) 1322 (in FIG. 3A, indicated as ICMP-Error {TEL=0}) indicative of a TEL value of “0”. The ICMP error is propagated in the opposite direction, and the TEP 1124 transmits, to the TEP 1122, an ICMP error 1324 (in FIG. 3A, indicated as ICMP-Error {TEL=1}) indicative of a TEL value of “1”.

The TEP 1124 can carry out the processing to store the TEL value (TEL value “0”) contained in the received ICMP error 1322. The TEL value stored here is used for the detection of a tunneling loop. It is also acceptable that the TEP 1124 stores the TEL value “1” contained in the ICMP error 1324 to be transmitted.

In addition, likewise, the TEP 1122 transmits, to the TEP1120, an ICMP error 1326 (in FIG. 3A, indicated as ICMP-Error {TEL=2}) indicative of a TEL value of “2”. This back propagation returns through ICMP errors 1328 and 1330 (in FIG. 3A, indicated as ICMP-Error {TEL=3}, ICMP-Error {TEL=4}) up to an ICMP error 1332 (in FIG. 3A, indicated as ICMP-Error {TEL=5}) indicative of the TEL value “5” of the original tunnel packet along the loop. At this time, as well as the processing on the ICMP error 1322, the TEP 1124 conducts the processing to store the TEL value in the ICMP error 1328.

The TEP 1120 cannot detect the presence of a tunneling loop. Accordingly, it is considered that the TEP 1120 performs the re-configuration to carry out the processing for increasing the TEL value in order to overcome this error. This processing is indicated as processing 1334 in FIG. 3A. In consequence, in this case, the TEP 1120 transmits a tunnel packet 1336 (in FIG. 3A, indicated as Pkt {TEL=6}) where the TEL value “6” was set at the beginning, so the tunneling loop repeatedly occurs. The TEP 1122 decrements the TEL value by one and transmits a tunnel packet 1338 (in FIG. 3A, indicated as Pkt {TEL=5}) where the TEL value is set at “5”. The message sequence after this is omitted in FIG. 3A. A person skilled in the art would recognize that, since the initial TEL value is incremented by one, the tunnel loop becomes longer by a length corresponding to one packet (one packet transfer). Moreover, the TEP 1124 stores the TEL value contained in a tunnel header of a packet even at the implementation of the packet transfer processing in conjunction with the packet 1336 with the TEL value “6” transmitted from the TEP 1120.

Moreover, when the TEL value reaches zero, as well as the operation mentioned above, the back propagation of the ICMP error is again implemented. The notable point is that the TEL value is incremented by one and, in the back propagation, each TEP receives an ICMP error indicative of the TEL value larger by one than that in the previous back propagation (messages 1322 to 1323). For example, the TEP 1124 first receives an ICMP error 1340 (in FIG. 3A, indicated as ICMP-Error {TEL=1}) indicative of the TEL value “1” (larger by one than the TEL value “0” in the ICMP error 1322). Following this, the TEP 1124 receives an ICMP error 1346 (in FIG. 3A, indicated as ICMP-Error {TEL=4}), again indicating the TEL value “4” (larger by one than the TEL value “3” in the ICMP error 1326), through the reverse-direction propagation of ICMP errors 1342 and 1344 (in FIG. 3A, indicated as ICMP-Error {TEL=2}, ICMP-Error {TEL=3}). Also in this case, the TEP 1124 stores the TEL values contained in the received ICMP errors 1340 and 1346.

Although in the above description the TEP 1124 stores the TEL values contained in both the received tunnel packet and ICMP error, the storage of the TEL value of the received tunnel packet and the storage of the TEL value of the ICMP error are the substantially equivalent processing and, preferably, the TEP 1124 stores the TEL value contained in only one of the received tunnel packet and the ICMP error.

In the operation shown in FIG. 3A, for example, the TEP 1124 can detect the presence of a tunneling loop on the basis of a TEL value acquired from an ICMP error. A description will be given hereinbelow of a method of detecting a tunneling loop on the basis of a TEL value acquired from an ICMP error.

The TEL values collected from the ICMP error by the TEP 1124 in the operation shown in FIG. 3A are shown in the form of a graph illustratively shown in FIG. 3. FIG. 3B is an illustration of one example of a graph illustratively showing a TEL value collected from an ICMP error by a tunnel entry point. In FIG. 3B is shown a graph of the TEL value from ICMP errors received by the TEP 1124 in the sequence chart shown in FIG. 3A. In FIG. 3B, the vertical axis 1350 indicates a TEL value indicated by a received ICMP error, while the horizontal axis 1352 represents the received ICMP error (or time).

An ICMP error first received by the TEP 1124 is the packet 1322 in FIG. 3A, which corresponds to a point 1360 (TEL value “0”) in FIG. 3B. An ICMP error subsequently received by the TEP 1124 is the packet 1328 in FIG. 3A, which corresponds to a point 1361 (TEL value “3”) in FIG. 3B. Moreover, an ICMP error further received by the TEP 1124 is the packet 1340 in FIG. 3A, which corresponds to a point 1362 (TEL value “2”) in FIG. 3B.

In FIG. 3B, assuming that the collection processing on a TEL value from an ICMP error is continuously conducted by the TEP 1124, points 1363 to 1369 to be acquired through further processing are additionally shown therein. From the graph 1370 (graph drawn by connecting consecutive points) shown in FIG. 3B, it is seen that a specific sawtooth-like pattern appears and peaks (see points 1361, 1363, 1365 and 1368) become higher. Thus, in a case in which the TEL values of the ICMP errors show a sawtooth-like pattern and a tendency for the peak to increase, it is possible to make a judgment that a tunneling loop exists and, on the basis of this characteristic, the TEP 1124 can detect the existence of a tunneling loop from the graph 1370.

In addition, in FIG. 3A, for example, the TEP 1124 can detect the existence of a tunneling loop on the basis of the TEL value acquired from a tunnel packet. A description will be given hereinbelow of a method of detecting a tunneling loop on the basis of a TEL value acquired from a tunnel packet.

TEL values collected from tunnel packets by the TEP 1124 in the operation shown in FIG. 3A are illustratively shown in the form of a graph in FIG. 3C. FIG. 3C is an illustration of one example of a graph illustratively showing TEL values collected from tunnel packets by a tunnel entry point according to an embodiment of the present invention. In FIG. 3C is shown a graph of TEL values contained in tunnel packets received by the TEP 1124 in a sequence chart shown in FIG. 3A. In FIG. 3C, the vertical axis 1356 depicts a TEL value contained in a received tunnel packet, while the horizontal axis 1358 indicates a received tunnel packet (or time).

A tunnel packet first received by the TEP 1124 is the packet 1312 in FIG. 3A, which corresponds to a point 1380 (TEL value “4”) in FIG. 3C. A tunnel packet secondly received by the TEP 1124 is the packet 1318 in FIG. 3A, which corresponds to a point 1381 (TEL value “1”) in FIG. 3C. A tunnel packet then received is the packet 1338 in FIG. 3A, which corresponds to a point 1382 (TEL value “5”) in FIG. 3C.

In FIG. 3C, assuming that the collection processing on a TEL value from a tunnel packet is continuously conducted by the TEP 1124, points 1383 to 1389 to be acquired through further processing are additionally shown therein. As well as the case shown in FIG. 3B, it is seen that the graph 1390 (graph drawn by connecting consecutive points) shown in FIG. 3C has a specific sawtooth-like pattern and the increasing peaks (see points 1380, 1382, 1384 and 1387). Thus, in a case in which the TEL values of the tunnel packets show a sawtooth-like pattern and a tendency for the peaks to become higher, it is possible to make a judgment that a tunneling loop exists and, on the basis of this characteristic, the TEP 1124 can detect the existence of a tunneling loop from the graph 1390.

As shown in FIG. 3B and FIG. 3C, the aforesaid graphs 1370 and 1390 have characteristics similar to each other, and a packet transferring apparatus (router, TEP or the like) collects TEL values of packets to be transferred to monitor whether or not a result of the collection agrees with a pattern unique to a tunneling loop, thus achieving the detection of a tunneling loop. As shown in FIG. 3B and FIG. 3C, the present invention does not depend upon the type and transmission direction of a packet containing a TEL value and, hence, it allows the employment of the same algorithm for the detection of a tunneling loop.

In the case of the method using ICMP errors for the collection of TEL values, the storage of TEL values is made only in a case in which an ICMP error occurs for some reason including the existence of a tunneling loop, which reduces the processing load in comparison with a case of always storing the TEL value of a tunnel packet to be transferred. On the other hand, according to the method using tunnel packets for the collection of TEL values, the presence of a tunneling loop is more promptly detectable in comparison with the method using ICMP errors for the collection of TEL values.

Furthermore, according to the present invention, even in a case in which a tunnel loop has a complicated arrangement, the detection of the tunneling loop is feasible. FIG. 4A is an illustration of another example of a network configuration in the case of the establishment of a tunneling loop in an embodiment of the present invention. FIG. 4A shows a case of a more complicated formation of a tunneling loop. In this case, the tunneling loop has two loops interwound with each other.

In FIG. 4A, a data packet transmitted by a source node (source) 1400 first passes through a path 1410 and reaches a tunnel entry point TEP 1420. Although it is also acceptable that a plurality of routers or tunnel entry points (not shown) lie on the path 1410, in this case, let it be assumed that the TEP 1420 is a first tunnel entry point which carries out the encapsulation on a data packet.

The packet encapsulated in the TEP 1420 is sent through a path 1411 to a TEP 1422, and the tunnel packet is further encapsulated therein. The packet encapsulated in the TEP 1422 is sent through a path 1412 to a TEP 1424, and the tunnel packet is further encapsulated therein.

The TEP 1424 has two routes available. For example, the TEP 1424 is designed to be capable of alternately use these two routes for load balancing (load dispersion). Although as one example a description will be given here of a case in which the TEP 1424 transmits packets alternately to the two routes for the load balancing, arbitrary load balancing is realizable.

In one (first route) of the two routes available by the TEP 1424, a packet is encapsulated into a tunnel returning through a path 1413 to the TEP 1420. The effect is formation of the first tunneling loop.

In the other (second route) of the two routes available by the TEP 1424, a packet is encapsulated into a tunnel directed through a path 1414 to a TEP 1426. In the TEP 1426, the packet is further encapsulated and sent through a path 1415 to a TEP 1428. Moreover, the packet is encapsulated in the TEP 1428 and returned through a path 1416 to the TEP 1422. The effect is the formation of the second tunneling loop.

In this connection, it is also acceptable that a plurality of router or tunnel entry points (not shown) lie on each of the paths 1411, 1412, 1413, 1414, 1415 and 1416.

In FIG. 4A, although the first and second tunneling loops form a tunneling loop, if an arbitrary tunnel entry point of the plurality of TEPs 1420, 1422, 1424, 1426 and 1428 establishing the tunneling loop has a tunneling loop detection function according to the present invention, the tunneling loop is detectable by this tunnel entry point.

Referring to FIG. 4B, a description will be given hereinbelow of one example of an operation according to the present invention in the network configuration shown in FIG. 4A. FIG. 4B is a sequence chart showing a different example of an operation according to an embodiment of the present invention.

In FIG. 4B, the message sequence starts at a source node 1400 which transmits a data packet 1430 (in FIG. 4B, indicated as Data). The TEP 1420 sets the TEL value at for example, “12” and encapsulates the data packet 1430 into a tunnel packet 1431. The packet 1431 (in FIG. 4B, indicated as Pkt {TEL=12}) arrives at the TEP 1422.

The TEP 1422 decrements the TEL value by one and encapsulates the packet 1431 into a tunnel packet 1432 where the TEL value is set at “11”. The packet 1432 (in FIG. 4B, indicated as Pkt {TEL=11}) passes through a path 1412 and reaches the TEP 1424.

The TEP 1424 decrements the TEL value by one and encapsulates the packet 1432 into a tunnel packet 1433 where the TEL value is set at “10”. The packet 1433 (in FIG. 4B, indicated as Pkt {TEL=10}) is sent through, for example, a path 1413 and a gain reaches the TEP 1420, thereby establishing a first tunneling loop.

With respect to the packet 1433 sent back through the first tunneling loop in this way, the TEP 1420 decrements the TEL value by one and encapsulates the packet 1433 into a tunnel packet 1434 where the TEL value is set at “9”. The packet 1434 (in FIG. 4B, indicated as Pkt {TEL=9}) passes through a path 1411 and reaches the TEP 1422.

The TEP 1422 decrements the TEL value by one and encapsulates the packet 1434 into a tunnel packet 1435 where the TEL value is set at “8”. The packet 1435 (in FIG. 4B, indicated as Pkt {TEL=8}) passes through a path 1412 and reaches the TEP 1424.

The TEP 1424 decrements the TEL value by one and encapsulates the packet 1435 into a tunnel packet 1436 where the TEL value is set at “7”. The packet 1436 (in FIG. 4B, indicated as Pkt {TEL=7}) is sent through, for example, a path 1414 at this time and reaches the TEP 1426.

The TEP 1426 decrements the TEL value by one and encapsulates the packet 1436 into a tunnel packet 1437 where the TEL value is set at “6”. The packet 1437 (in FIG. 4B, indicated as Pkt {TEL=6}) passes through a path 1415 and reaches the TEP 1428.

The TEP 1428 decrements the TEL value by one and encapsulates the packet 1437 into a tunnel packet 1438 where the TEL value is set at “5”. The packet 1438 (in FIG. 4B, indicated as Pkt {TEL=5}) passes through a path 1416 and reaches the TEP 1422, thereby establishing a second tunneling loop. Incidentally, a packet is transmitted within the first and second tunneling loops until the TEL value reaches zero.

Following this, the packet tunneling is repeated in like manner (packets 1439 to 1442 (in FIG. 4B, indicated as Pkt {TEL=4}, Pkt {TEL=3}, Pkt {TEL=2}, Pkt {TEL=1}), and when the TEP 1424 encapsulates the packet 1442 into a packet 1443 and transmits the packet 1443 (in FIG. 4B, indicated as Pkt {TEL=0}) to the TEP 1426, the TEL values reaches zero.

When the TEL value reaches zero, the receiver (i.e., TEP 1426) of the packet 1443 transmits, to the transmitter (TEL 1424), an ICMP error 1444 (in FIG. 4B, indicated as ICMP-Error {TEL=0}) indicative of a TEL value “0”. The ICMP error is propagated in the opposite direction, and the TEP 1424 transmits, to the TEP 1422, an ICMP error 1445 (in FIG. 4B, indicated as ICMP-Error {TEL=1}) indicative of a TEL value “1”. Likewise, the TEP 1422 notifies, to the TEP 1420, an ICMP error 1446 (in FIG. 4B, indicated as ICMP-Error {TEL=3}) indicative of a TEL value “2”. In the back propagation, within the first and second tunneling loops, ICMP errors 1447 to 1455 (in FIG. 4B, indicated as ICMP-Error {TEL=3 to 11}) are transmitted up to an ICMP error 1456 (in FIG. 4B, indicated as ICMP-Error {TEL=12}) indicative of the TEL value “12” of the original tunnel packet.

Although not shown in FIG. 4B, a tunnel entry point having a tunneling loop detection function according to the present invention is made to conduct the processing for storing the TEL values contained in tunnel packets and/or ICMP errors.

For example, in a case in which the TEP 1420 has the tunneling loop detection function according to the present invention and carries out the processing to store a TEL value contained in an ICMP error, in the operation shown in FIG. 4B, the TEL values collected from ICMP errors by the TEP 1420 are indicated in the form of a graph illustratively shown in FIG. 4C. FIG. 4C is an illustration of a different example of a graph illustratively showing TEL values collected from ICMP errors by a tunnel entry point.

In FIG. 4C is shown a graph of the TEL values contained ICMP errors received by the TEP 1420 in the sequence chart shown in FIG. 4B. In FIG. 4C, the vertical axis 1460 indicates a TEL value contained in a received ICMP error, while the horizontal axis 1462 represents the received ICMP error (or time).

An ICMP error first received by the TEP 1420 is the packet 1446 in FIG. 4B, which corresponds to a point 1470 (TEL value “2”) in FIG. 4C. An ICMP error subsequently received by the TEP 1420 is the packet 1453 in FIG. 4B, which corresponds to a point 1471 (TEL value “9”) in FIG. 4C. Moreover, an ICMP error further received by the TEP 1420 is the packet 1456 in FIG. 4B, which corresponds to a point 1472 (TEL value “12”) in FIG. 4C.

In FIG. 4C, assuming that the collection processing on a TEL value from an ICMP error is continuously conducted by the TEP 1420, points 1473 to 1476 to be acquired through further processing are additionally shown therein. Also in the graph 1480 (graph drawn by connecting consecutive points) shown in FIG. 4C, it is seen that there develops a characteristic in the case of the presence of a tunneling loop, that is, a specific sawtooth-like pattern appears and peaks become higher.

Moreover, for example, in a case in which the TEP 1424 has the tunneling loop detection function according to the present invention and carries out the processing to store a TEL value contained in an ICMP error, in the operation shown in FIG. 4B, the TEL values collected from ICMP errors by the TEP 1424 are indicated in the form of a graph illustratively shown in FIG. 4D. FIG. 4D is an illustration of a different example of a graph illustratively showing TEL values collected from ICMP errors by a tunnel entry point.

In FIG. 4D is shown a graph of the TEL values contained ICMP errors received by the TEP 1424 in the sequence chart shown in FIG. 4B. In FIG. 4D, the vertical axis 1466 indicates a TEL value contained in a received ICMP error, while the horizontal axis 1468 represents the received ICMP error (or time).

An ICMP error first received by the TEP 1424 is the packet 1444 in FIG. 4B, which corresponds to a point 1490 (TEL value “0”) in FIG. 4D. An ICMP error subsequently received by the TEP 1424 is the packet 1447 in FIG. 4B, which corresponds to a point 1491 (TEL value “3”) in FIG. 4D. Moreover, an ICMP error further received by the TEP 1424 is the packet 1451 in FIG. 4B, which corresponds to a point 1492 (TEL value “7”) in FIG. 4D. Still moreover, an ICMP error further received by the TEP 1424 is the packet 1454 in FIG. 4B, which corresponds to a point 1493 (TEL value “10”) in FIG. 4D.

In FIG. 4D, assuming that the collection processing on a TEL value from an ICMP error is continuously conducted by the TEP 1424, points 1494 to 1498 to be acquired through further processing are additionally shown therein. Also in the graph 1484 (graph drawn by connecting consecutive points) shown in FIG. 4D, it is seen that there develops a characteristic in the case of the presence of a tunneling loop, that is, a specific sawtooth-like pattern appears and peaks become higher.

As shown in FIG. 4C and FIG. 4D, even in a case in which a tunneling loop is formed in a complicated fashion, for example, when a plurality of loops establishes a tunneling loop because of load balancing, the detection of the tunneling loop becomes feasible by referring to the statistics of the TEL values of transfer packets for discovering a pattern indicative of a tunneling loop. The statistics of the TEL values related to all types of tunneling loops show the above-mentioned sawtooth-like patterns.

Furthermore, in reality, the data source nodes 1100 and 1400 would probably transmit a plurality of packets for a short period of time, such that one or more packets exist in a tunneling loop in a moment. Although examples of ideal variation patterns of statistics of TEL values in the case of taking note of only one packet in a tunneling loop are shown in FIGS. 3B, 3C, 4C and 4D, the statistic of the TEL values collected by a tunnel entry point can be as a graph 1510 shown in FIG. 5.

FIG. 5 is an illustration of one example of a graph showing TEL values actually collected from ICMP errors by a tunnel entry point, in an embodiment of the present invention. Although the graph 1510 shown in FIG. 5 appears to be irregular (disorderly) in comparison with the above-mentioned graphs 1370, 1390, 1480 and 1484 respectively shown in FIGS. 3B, 3C, 4C and 4D, when the average of the statistics is calculated for a short time window, a smoother graph 1520 is obtainable. In the case of the occurrence of a tunneling loop, this smoother graph 1520 has a pattern closely resembling a pattern unique to a tunneling loop, that is, it shows that a sawtooth-like pattern develops and peaks become higher. Therefore, the detection of this pattern enables the detection of the presence of a tunneling loop.

Information on a large number of packets are contained in the graph 1510 shown in FIG. 5, and even if a large number of packets are transmitted within a tunneling loop, information (information close to the above-mentioned graph 1370, 1390, 1480 or 1484 shown in FIG. 3B, 3C, 4C or 4D) on a single packet or a small number of packets are obtainable by means of the identification and information management on a packet to be transferred. For example, when each tunnel entry point adds unique information (for example, identification information on the first tunnel entry point, random number, sequence number or a combination thereof) onto the outermost header of a tunnel packet, each tunnel entry point can specify one packet or packets on the same transfer path. In this case, when the tunnel entry point discovers the already added unique ID information at the outermost header of a tunnel packet to be transferred, the tunnel entry point copies the discovered unique ID information onto the outermost header of a tunnel packet generated by the tunnel entry point itself. Thus, the identification information on the first tunnel entry point of tunnel entry points, which can handle the present invention, is always maintainable on the outermost header of a tunnel packet. In addition, it is also appropriate that the tunnel entry point manages a TEL value for each source address and destination address of a packet. Through the employment of the unique ID information or individually managed TEL value, a tunnel entry point involved in a plurality of loops can carry out different statistical processing on a different loop and, for example, when a pattern unique to a specified tunneling loop is detected through the use of diverse executable methods, the detection of the tunneling loop becomes achievable with higher accuracy.

Furthermore, for realizing the present invention, it is preferable that a tunnel entry point employs a functional architecture shown in FIG. 6. FIG. 6 shows components for a tunneling loop detection function (apparatus for controlling a tunneling loop) included in a tunnel entry point.

According to an embodiment of the present invention, as shown in FIG. 6, the functional architecture of a tunnel entry point is composed of a routing unit 1220 and one or a plurality of network interfaces 1210. Only one network interface is shown in FIG. 6.

Each network interface 1210 is a functional block representing all network hardware, software and protocol needed for the tunnel entry point 1200 to make communications through a path 1285 with other nodes through the use of a link access technology.

For example, in the 7-layer model of OSI (Open System Interconnect) of ISO (International Standards Organization), the network interface 1210 contains a physical layer and a data link layer.

When the network interface 1210 has received a packet, for further processing, the network interface 1210 hands over the packet through a data path 1295 to the routing unit 1220. Likewise, at the packet transmission, for the transmission through the data path 1295, the routing unit 1220 hands over the packet to the corresponding network interface 1210.

Moreover, the routing unit 1220 conducts all the processing regarding the routing in the internet working layer. Under the OSI model, the routing unit 1220 contains all the functions in the network layer.

Basically, the routing unit 1220 carries out IPv6 or common tunneling function. In the routing unit 1220, there exist a routing table 1230 and a tunneling module 1240.

The routing table 1230 includes information to be used when the routing unit 1220 determines a path. The routing table 1230 is arranged like a list of entries and, preferably, each entry contains a destination field and a next hop field. The destination field stores a full designation address or a prefix of the destination address, while the next hop field describes a transfer place of a packet having a designation address agreeing with the value stored in the destination field.

In addition, the tunneling module 1240 conducts the establishment, maintenance and cancellation of an IP tunnel when needed. For example, under the NEMO basic support, a mobile router establishes a bi-directional tunnel with respect to its own home agent. This is maintained by the tunneling module 1240.

A person skilled in the art would recognize that it is preferable that the tunneling module 1240 creates a virtual network interface known as a tunnel interface. It is seem to the routing unit 1220 that this tunnel interface is equivalent to the other network interface 1210.

In the tunneling module 1240, there exists a loop detection module 1250. This loop detection module 1250 has a function to check whether or not a TEL option exists in a received packet (tunnel packet and/or ICMP error) and, if the TEL option exists therein, store the TEL value contained therein. Moreover, the loop detection module 1250 implements a tunneling loop detection algorithm so as to presume, on the basis of the TEL value stored, whether or not a tunneling loop exists and, in the case of the detection of the presence of the tunneling loop, triggers an error. Still moreover, the loop detection module 1250 further has a function to insert a TEL option into a tunnel packet to be sent and to set a TEL value and other additional information (for example, ID information and others) with respect to the TEL option.

A person skilled in the art would recognize that the functional architecture of the tunnel entry point shown in FIG. 6 includes only a functional block still needed for realizing the tunnel entry point and in fact there is a case in which other functions are additionally necessary. For example, in a case in which a tunnel entry point is a home agent, there is a need to add a function (for example, binding cache entry, and others) for providing a home agent capability.

Still additionally, according to an embodiment of the present invention, it is preferable that the loop detection module 1250 of the tunnel entry point has a statistic collection function and a statistic comparison function as shown in FIG. 7. FIG. 7 is an illustration of one example of a configuration of a loop detection module of a tunnel entry point according to an embodiment of the present invention.

The loop detection module 1250 shown in FIG. 7 is designed to collect a predetermined parameter (for example, a TEL value) acquired from a received packet and is made to send a signal indicative of a possibility of occurrence of a tunneling loop.

In FIG. 7, an input node 1610 serves as an input point for collected statistic sample (for example, TEL value of received tunnel packet or TEL value of received ICMP error). A value inputted to the input node 1610 are supplied to two different units. That is, the value inputted to the input node 1610 is supplied through a data path 1650-1 to a register 1620-1 and further fed through a data path 1651 to a comparator 1630.

The register 1620-1 has a function to store a value acquired for one unit time (corresponding to one packet). In a case in which a new value is inputted from the data path 1650-1 to the register 1620-1, the current value stored in the register 1620-1 is outputted through a data path 1650-2, while the new register is stored in the register 1620-1. The value outputted through the data path 1650-2 is stored in the next register 1620-2 to be shifted.

The loop detection module 1250 has n registers 1620-1 to 1620-n as mentioned above, and the registers 1620-1 to 1620-n are connected in series, where n depicts an integer equal to or more than two. The series of registers 1620-1 to 1620-n constitute a delay filter based on a conventional technique. Each register 1620-y is made to store the value stored in the former-state register 1620-x (y=x+1: x, y represents a positive integer from 1 to n) for the last unit time.

There are two data paths to which the values stored in the respective registers 1620-x are outputted. That is, there are the data path 1650-y (y=x+1) through which the output value is fed to the next register 1620-y and the data path 1652 through which the output value is fed to the comparator 1630. However, with respect to the last register 1650-n, as exception, there is only the data path 1620-n through which the output value is supplied to the comparator 1630.

The comparator 1630 is designed to make a comparison between a new input value from the data path 1651 and the value (the value stored in each of the registers 1620-1 to 1620-n) previously inputted from each of the data paths 1652-1 to 1652-n so as to output a value indicative of whether a tunneling loop has been detected or not. In this case, it is also appropriate that, only when the detection shows apossibility of occurrence of a tunneling loop, the comparator 1630 outputs a tunneling loop detection notifying signal to an output node 1640.

In fact, there are various methods of mounting the comparator 1630. The present invention is not limited to a special one. For example, the comparator 1630 is realizable with a weighted linear combiner. In this case, the output value to the data path 1654 is a weighted sum of all the input values from the data paths 1651 and 1651-1 to 1651-n. For example, the respective weights can be determined by collecting samples of a plurality of values obtained from both flows which include a tunneling loop and flows which do not include a tunneling loop, and it is preferable that an output value is set so as to minimize the square error from a desired output.

Another approach is to realize the comparator 163 by use of a neural network. For example, the neural network is designed to exhibit a training function to provide a desired output through the use of values acquired from both flows which involve a tunneling loop and flows which do not involve a tunneling loop. Although a particularly useful type of neural network is a multi-layer perception (MLP), this requires large-scale training utilizing an error back propagation method. Another useful type of neural network is a radial basis function (RBF) network. In the case of this RBF network, the training is relatively easy, and it is possible to determine a cluster center of the radial basis function through the use of a cluster algorithm. Moreover, it is also possible to determine the linear weights through the use of a normal least square error algorithm.

Although the present invention has been herein shown and described with the contents conceived to be the most practical and preferred embodiment, it will be appreciated by those skilled in the art that various modifications may be made in details of design and parameters without departing from the scope and ambit of the invention.

The respective functional blocks used in the above description of the embodiment of the present invention are typically realized with an LSI (Large Scale Integration) which is an integrated circuit. It is also acceptable that these blocks are individually formed as one chip, or that a portion of or all of these blocks are formed as one chip. Although an LSI is taken in this case, it is sometimes referred to as an IC (Integrated Circuit), system LSI, super LSI or ultra LSI according to the level of integration.

Moreover, the technique for the formation of an integrated circuit is not limited to the LSI, but it is also realizable with a dedicated circuit or a general-purpose processor. After the manufacturing of an LSI, it is also acceptable to utilize an FPGA (Field Programmable Gate Array) which enables the programming or a reconfigurable processor which allows the reconfiguration of connections and setting of circuit cells in the interior of the LSI.

Still moreover, if a technique for the formation of an integrated circuit replaceable with the LSI appears owing to advance in semiconductor technology or a different technology derived therefrom, the functional blocks can naturally be integrated through the use of this technique. For example, a biotechnology or the like may be applicable.

### INDUSTRIAL APPLICABILITY

The present invention provides an advantage in that a packet transferring apparatus (particularly, a tunnel entry point) can detect the presence of a tunneling loop and is applicable to communication fields in a packet-switched data communication network, particularly to technical fields regarding packet encapsulation (packet tunneling).

1. An apparatus for controlling a tunneling loop detection, which is located in a packet transferring apparatus having a packet transferring function, comprising:
information collecting means for collecting information included in a packet;
information accumulating means for accumulating the information collected by said information collecting means; and
tunneling loop detecting means for detecting whether or not a tunneling loop has occurred, on the basis of the information accumulated in said information accumulating means.

2. The apparatus for controlling a tunneling loop detection according to claim 1, wherein said information collecting means is designed to collect a value of a tunnel encapsulation limit option included in a tunnel header of the packet.

3. The apparatus for controlling a tunneling loop detection according to claim 1, wherein said information collecting means is designed to collect a value of a tunnel encapsulation limit option included in an ICMP error packet.

4. The apparatus for controlling a tunneling loop detection according to claim 1, wherein said information accumulating means is designed to store the information included in each of a predetermined number of packets from a lastly received packet to a transferred packet preceding by the predetermined number with respect to the lastly received packet.

5. The apparatus for controlling a tunneling loop detection according to claim 1, wherein said tunneling loop detecting means carries out statistical processing on the information accumulated by said information accumulating means to estimate whether or not the tunneling loop has occurred, on the basis of a result of the statistical processing.

6. The apparatus for controlling a tunneling loop detection according to claim 1, wherein said tunneling loop detecting means conducts processing on the information accumulated in said information accumulating means to obtain an increase/decrease pattern of a value indicated by the information included in the packet relative to time and, when a result of the processing shows that the obtained pattern agrees with a sawtooth-like pattern unique to the occurrence of a tunneling loop, makes a judgment that the tunneling loop has occurred.

7. The apparatus for controlling a tunneling loop detection according to claim 1, further comprising packet selecting means for identifying the packet individually or according to specified group, wherein said tunneling loop detecting means analyzes the information accumulated by said information accumulating means for each individual packet or each group selected by said packet selecting means so as to detect whether or not the tunneling loop has occurred.

8. The apparatus for controlling a tunneling loop detection according to claim 7, wherein said packet selecting means is made to identify the packet on the basis of identification information appended to the packet.

9. The apparatus for controlling a tunneling loop detection according to claim 8, further comprising identification information appending control means for executing control so that the identification information appended to the packet is held in an outermost header of the packet.

10. The apparatus for controlling a tunneling loop detection according to claim 7, wherein said packet selecting means is made to set the group for each set of a source address and destination address of the packet.
